(19) United States
(12) Patent Application Publication
(10) Pub. No.: US 2021/0070891 A1
(43) Pub. Date: Mar. 11, 2021

(54) REFINED BETA-GLUCAN AND METHODS OF MAINTAINING FILTERABILITY OF BETA-GLUCAN COMPOSITIONS AT VARIOUS SALINITIES

(71) Applicant: CARGILL, INCORPORATED, Wayzata, MN (US)

(72) Inventors: Mohannad KADHUM, St. Louis Park, MN (US); Jeffrey J. MALSAM, Excelsior, MN (US); Eric Stanley SUMNER, Minneapolis, MN (US)

(73) Assignee: CarGillL, Incorporated, Wayzata, MN (US)

(21) Appl. No.: 16/646,882

(22) PCT Filed: Sep. 27, 2018
(86) PCT No.: PCT/US2018/053162

§ 371 Date: Mar. 12, 2020

Related U.S. Application Data
(60) Provisional application No. 62/564,609, filed on Sep. 28, 2017.

(51) Int. Cl. C08B 37/00; C09K 8/035

(52) U.S. Cl. CPC C08B 37/0024; C09K 8/035

(57) ABSTRACT

Various aspects relate to refined beta-glucans and methods of maintaining filterability of compositions including beta-glucans at various salinities. A refined beta-glucan forms an aqueous beta-glucan composition including 1 g/L of the refined beta-glucan, the aqueous beta-glucan composition having a salinity of 100,000 ppm TDS or less and having a Filterability Ratio of less than 2 at a temperature of at least 50° C.

### CROSS-REFERENCE TO RELATED APPLICATIONS

This International application claims the benefit of U.S. Provisional Patent Application Ser. No. 62/564,609, filed on Sep. 28, 2017, entitled REFINED BETA-GLUCANS AND METHODS OF MAINTAINING FILTERABILITY OF BETA-GLUCAN COMPOSITIONS AT VARIOUS SALINITIES, which application is hereby incorporated by reference herein in its entirety.

### BACKGROUND

Beta-glucans can be used as thickeners in aqueous fluids for treatment of subterranean formations, such as for enhanced oil recovery (EOR). However, at various salinity levels, it can be difficult or impossible to maintain reasonable filterability (e.g., resistance to clogging of subterranean formation pores) of aqueous compositions including conventional forms of beta-glucans.

### SUMMARY OF THE INVENTION

In various aspects, the present invention provides a refined beta-glucan that forms an aqueous beta-glucan composition including 1 g/L of the refined beta-glucan, the aqueous beta-glucan composition having a salinity of 100,000 ppm TDS or less and having a Filterability Ratio of less than 2 at a temperature of at least 50° C.

In various aspects, the present invention provides a refined beta-glucan that forms an aqueous beta-glucan composition including 1 g/L of the refined beta-glucan, the aqueous beta-glucan composition having a salinity of 100,000 ppm TDS or less and having a Filterability Ratio of less than 1.2 at a temperature of at least 40° C.

In various aspects, the present invention provides an aqueous beta-glucan composition that include the refined beta-glucan at any suitable concentration, temperature, and salinity conditions, such as a concentration of 1 g/L or a different concentration, such as a temperature of at least 50° C. or a different temperature, such as a salinity of 100,000 ppm TDS or less or a different salinity.

In various aspects, the present invention provides a method of maintaining the Filterability Ratio of an aqueous beta-glucan composition, such as an aqueous beta-glucan composition including the refined beta-glucan, or such as an aqueous beta-glucan composition including another suitable beta-glucan. The method includes controlling temperature of the aqueous beta-glucan composition, salinity of the aqueous beta-glucan composition, or a combination thereof, such that the Filterability Ratio of the aqueous beta-glucan composition is less than 2.

In various aspects, the present invention provides a method of treating a subterranean formation. The method includes placing the aqueous beta-glucan composition in a subterranean formation. The Filterability Ratio of the aqueous beta-glucan composition in the subterranean formation is less than 2.

In various aspects, the present invention provides a method of treating a subterranean formation. The method includes placing the aqueous beta-glucan composition in a subterranean formation. The method includes, before the placing, during the placing, after the placing, or a combination thereof, heating the aqueous beta-glucan composition, diluting the aqueous beta-glucan composition to reduce the salinity thereof, or a combination thereof, such that the Filterability Ratio of the aqueous beta-glucan composition in the subterranean formation is less than 2.

Various aspects of the present invention have advantages over other beta-glucans, aqueous compositions including the same, and methods of using the same, at least some of which are unexpected. For example, some subterranean formation treatment fluids can clog pores and flowpaths in subterranean formations which can result in decreased production rates or increased pressures that can damage the formation. In various aspects, an aqueous composition including the refined beta-glucan of the present invention can provide higher filterability (e.g., lower Filterability Ratio) than aqueous compositions made with other beta-glucans. In various aspects, an aqueous composition including the refined beta-glucan of the present invention and having a particular concentration of the beta-glucan and a particular salinity can provide a higher filterability at a given temperature than a comparative aqueous composition including a different beta-glucan at the same salinity, concentration, and temperature. In various aspects of the present invention, for an aqueous composition including the refined beta-glucan, the relationship between temperature, salinity, and Filterability Ratio can remain substantially constant during variation of pH, variation of the concentration of the beta-glucan, variation of the divalent to monovalent ion ratio in the composition, or a combination thereof. In various aspects of the present invention, at the time of placing an aqueous beta-glucan composition in the subterranean formation the Filterability Ratio of the composition can be greater than 2, but after being placed in the subterranean formation the temperature, salinity, or a combination thereof, of the aqueous beta-glucan composition can be affected by the subterranean formation such that the Filterability Ratio of the aqueous beta-glucan composition in the subterranean formation becomes less than 2, or less than 1.2.

Some beta-glucans can require long mixing times, high shear rates, or a combination thereof, to disperse the beta-glucan in water. In various aspects, the refined beta-glucan of the present invention, in a dry or concentrated liquid state (e.g., a suspension or a solution), can more easily be combined with aqueous liquids to form homogeneous solutions than other beta-glucans. In various aspects, the refined beta-glucan of the present invention can provide a homogeneous mixture of water and the beta-glucan using a shorter mixing time, less shear, or a combination thereof, as compared to other beta-glucans.

With conventional beta-glucans it can be difficult or impossible to prepare fully-diluted and ready-to-use aqueous solutions using salt water, especially with high salt concentrations, due to problems such as insufficient viscosity and insufficient dispersion of the beta-glucan in the water. In various aspects, the refined beta-glucan of the present invention can be diluted using salt water to form a homogenous mixture of the water and the beta-glucan with better dispersion of the beta-glucan (e.g., more dispersed), less mixing time or lower shear rate for preparation, better viscosity performance (e.g., faster viscosity build or higher final viscosity), or a combination thereof, as compared to other beta-glucans.

Conventional beta-glucans can suffer from slow or insufficient viscosity build during mixing with water, such that an ultimate viscosity of the fully-diluted and dispersed beta-glucan can only be achieved with long mixing times or can never be achieved. In various aspects, a solution including the refined beta-glucan of the present invention can build viscosity faster (e.g., can reach maximum viscosity more quickly and easily) than solutions made with existing commercially available beta-glucan materials. Some beta-glucans can form fully-diluted and ready-to-use treatment fluids that perform poorly under heated conditions (e.g., 70° C. to 150° C.), such as having insufficient or decreasing viscosity. In various aspects, the refined beta-glucan of the present invention can be used to form a homogenous mixture of the water and the beta-glucan with better performance under heated conditions, such as higher viscosity or less or no viscosity degradation, as compared to other beta-glucans.

In various aspects, a solution including the refined beta-glucan of the present invention can maintain viscosity more effectively during various filtration procedures, such as various procedures for treatment of a subterranean formation, as compared to solutions formed with other beta-glucans. In various aspects, a solution of the refined beta-glucan of the present invention used for treatment of a subterranean formation can have a lower injection pressure at the same viscosity and the same injection rate (e.g., at the same injection pressure a higher injection rate can occur), as compared to solutions formed with other viscosifiers such as other beta-glucans.

In various aspects, the refined beta-glucan of the present invention can have increased thermal stability, as indicated by higher Tg values, than other beta-glucans, allowing higher maximum reservoir temperatures for treatment of subterranean formations, such as for enhanced oil recovery. In various aspects, the refined beta-glucan of the present invention can resist or avoid forming solid precipitants in the presence of high levels of Ca²⁺ and Mg²⁺ ions to a greater extent than other viscosifying materials.

In various aspects a low impurity level of the refined beta-glucan of the present invention can reduce mineral and nutrient loading of a solution formed therefrom, as compared to solutions formed from other beta-glucans. In various aspects, filtration of a solution of the refined beta-glucan of the present invention prior to injection into a subterranean formation can be conducted with less loading of the filter (e.g., less accumulation on the filter per time), with a need for less cleaning or replacement of filters as compared to solutions formed with other viscosifiers such as other beta-glucans.

In various aspects, the particle size distribution of the refined beta-glucan of the present invention can provide good flow characteristics for transport (e.g., can be a narrow distribution to facilitate flow characteristics), can be large enough to avoid explosion risks or dust health hazards, and can be small enough to accelerate solubilization.

### BRIEF DESCRIPTION OF THE FIGURES

The drawings illustrate generally, by way of example, but not by way of limitation, various aspects of the present invention.

FIG. 1A illustrates a top view of a stirrer, in accordance with various aspects.

FIG. 1B illustrates a side view of the bend of the stirrer, as viewed perpendicularly to one the slot adjacent to the bend, in accordance with various aspects.

FIG. 2 illustrates temperature versus salinity for various aqueous beta-glucan composition, in accordance with various aspects.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “standard temperature and pressure” as used herein refers to 20° C. and 101 kPa.

The term “downhole” as used herein refers to under the surface of the earth, such as a location within or fluidly connected to a wellbore.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein, “treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, water shut-off, conformance, and the like.

As used herein, a “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some aspects, a flow pathway can be a water source and can include water. In some aspects, a flow pathway can be a petroleum source and can include petroleum. In some aspects, a flow pathway can be sufficient to divert from a wellbore, fracture, or flow pathway connected thereto at least one of water, a downhole fluid, or a produced hydrocarbon.

### Refined Beta-Glucan and Aqueous Composition Including the Same.

In various aspects, the present invention provides a refined beta-glucan, which can be neat or in solution such as an aqueous solution (e.g., an aqueous beta-glucan composition that includes the refined beta-glucan). The beta-glucan is refined (e.g., isolated, separated, or purified) from a crude beta-glucan, such as from fermentation broth including microorganisms that generated the beta-glucan, or such as from any suitable commercially available beta-glucan material, such as Cargill's Actigum® CS-6 or CS-11 materials. The refined beta-glucan can be free of other materials, such as free of a fermentation broth and associated contaminants therein. The refined beta-glucan can be any suitable beta-glucan that can be dispersed in an aqueous liquid to provide an aqueous beta-glucan composition having the relationship between temperature, salinity, and Filterability Ratio described herein. The beta-glucan can be a 1,3 beta-glucan. The beta-glucan can be a 1,3-1,6 beta-D-glucan, such as having a main chain from beta-1,3-glycosidically bonded glucose units, and side groups which are formed from glucose units and are beta-1,6-glycosidically bonded thereto. Examples of such 1,3 beta-D-glucans include curdlan (a homopolymer of beta-(1,3)-linked D-glucose residues produced from, e.g., Agrobacterium spp.), grifolan (a branched beta-(1,3)-D-glucan produced from, e.g., the fungus Grifola frondosa), lentinan (a branched beta-(1,3)-D-glucan having two glucose branches attached at each fifth glucose residue of the beta-(1,3)-backbone produces from, e.g., the fungus Lentinus eeodes), schizophyllan (a branched beta-(1,3)-D-glucan having one glucose branch for every third glucose residue in the beta-(1,3)-backbone produced from, e.g., the fungus Schizophyllan commune), scleroglucan (a branched beta-(1,3)-D-glucan with one out of three glucose molecules of the beta-(1,3)-backbone being linked to a side D-glucose unit by a (1,6)-beta bond produced from, e.g., fungi of the Sclerotium spp.), SSG (a highly branched beta-(1,3)-glucan produced from, e.g., the fungus Sclerotinia sclerotiorum), soluble glucans from yeast (a beta-(1,3)-D-glucan with beta-(1,6)-linked side groups produced from, e.g., Saccharomyces cerevisiae), laminarin (a beta-(1,3)-glucan with beta-(1,3)-glucan and beta-(1,6)-glucan side groups produced from, e.g., the brown algae Laminaria digitata), and cereal glucans such as barley beta glucans (linear beta-(1,3)(1,4)-D-glucan produced from, e.g., Hordeum vulgare, Avena sativa, or Triticum vulgare).

The beta-glucan can be scleroglucan, a branched beta-glucan with one out of three glucose molecules of the beta-(1,3)-backbone being linked to a side D-glucose unit by a (1,6)-beta bond produced from, e.g., fungi of the Sclerotium. The beta-glucan can be schizophyllan, a branched beta-glucan having one glucose branch for every third glucose residue in the beta-(1,3)-backbone produced from, e.g., the fungus Schizophyllan commune. Fungal strains that secrete such glucans are known to those skilled in the art. Examples include Schizophyllum commune, Sclerotium rolfsii, Sclerotium glucanicum, Monilinla fructigena, Lentinula edodes, or Botrygs cinera. Particularly, scleroglucan and schizophyllan can include a repeat unit that is three beta-1,3-glycosidically bonded glucose units and one beta-1,6-glycosidically bonded glucose side unit that can be connected to any of the three beta-1,3-glucose units, such as the middle beta-1,3 glucose. The beta glucan described herein can include 90% of such repeating units in its polymeric chain (e.g., 90 mol % of the repeating units in the polymer chain can be such a repeat unit).

The beta-glucan can have desirable characteristics for treatment of subterranean formations as described in U.S. patent publication no. 2012/0205099.

The refined beta-glucan can form (e.g., can be used to form) an aqueous beta-glucan composition including the refined beta-glucan, wherein the aqueous beta-glucan composition has a certain Filterability Ratio at a given concentration, salinity, and temperature. The refined beta-glucan is not required to actually be in the form of the aqueous beta-glucan composition; rather, the beta-glucan is such that is can be used to form an aqueous beta-glucan solution having the specified properties. The refined beta-glucan can be in the form of a powder when free of solvent; or can be included in a liquid (e.g., a liquid that includes the powder therein in a dissolved state, undissolved state, or a combination thereof) such as a liquid concentrate, an aqueous beta-glucan composition having any suitable concentration of the refined beta-glucan, or a combination thereof. The specified properties of the aqueous solution including the refined beta-glucan are a way to characterize the refined beta-glucan, like other analytical methods such as melting point, mass spectrometry, or nuclear magnetic resonance spectroscopy. While the present invention provides aqueous beta-glucan compositions having any suitable proportion of water therein, for purposes of characterizing the refined beta-glucan the liquid portion of the aqueous solution including the beta-glucan at 1 g/L and having the specified properties can be substantially 100 vol % water. In the aqueous beta-glucan composition, the refined beta-glucan is substantially homogeneously dispersed therein as a dissolved beta-glucan (e.g., no visible particles), a dispersed beta-glucan (e.g., homogeneously dispersed but having visible particles), or a combination thereof. In some aspects, the beta-glucan acts as a viscosifier, and the beta-glucan can be dissolved, dispersed, or a combination thereof, in the aqueous composition, such that the aqueous composition has substantially the highest viscosity possible (e.g., the ultimate viscosity) for an aqueous mixture including that particular concentration of the beta-glucan. As used herein, the ultimate viscosity is the highest possible viscosity of a solution having the same composition, and can be estimated as the viscosity of a solution of the beta-glucan in water prepared by subjecting to a shear of about 260,000 s⁻¹ for about 0.06 s to about 6 s.

The 1 g/L aqueous beta-glucan composition including the refined beta-glucan and having the specified relationship between temperature, salinity, and Filterability Ratio can be formed using any suitable type of water, such as fresh water, salt water, brine, produced water, flowback water, brackish water, sea water, synthetic sea water, or a combination thereof. For a salt water, the one or more salts therein can be any suitable salt, such as at least one of NaBr, CaCl₂, CaBr₂, ZnBr, KCl, NaCl, a carbonate salt, a sulfonate salt, sulfite salts, sulfide salts, a phosphate salt, a phosphonate salt, a magnesium salt, a sodium salt, a calcium salt, a bromide salt, a formate salt, an acetate salt, a nitrate salt, or a combination thereof. The water can have any suitable total dissolved solids level, such as about 1,000 mg/L to about 250,000 mg/L, or about 1,000 mg/L or less, or about 0 mg/L, or about 5,000 mg/L, 10,000, 15,000, 20,000, 25,000, 30,000, 40,000, 50,000, 75,000, 100,000, 125,000, 150,000, 175,000, 200,000, 225,000, or about 250,000 mg/L or more. The water can have any suitable salt concentration, such as about 1,000 ppm to about 400,000 ppm, about 1,000 ppm to about 300,000 ppm, or about 1,000 ppm to about 150,000 ppm, or about 0 ppm, or about 1,000 ppm or less, or about 5,000 ppm, 10,000, 15,000, 20,000, 25,000, 30,000, 40,000, 50,000, 75,000, 100,000, 125,000, 150,000, 175,000, 200,000, 225,000, 250,000, 275,000, 300,000, 350,000, or about 400,000 ppm or more. In some examples, the water can have a concentration of at least one of NaBr, CaCl₂, CaBr₂, ZnBr, KCl, and NaCl of about 0.1% w/v to about 20% w/v, or about 0%, or about 0.1% w/v or less, or about 0.5% w/v, 1, 2, 3, 4, 5, 6, 7, 8, 9, 10, 11, 12, 13, 14, 15, 16, 17, 18, 19, 20, 21, 22, 23, 24, 25, 26, 27, 28, 29, or about 30% w/v or more.

The aqueous beta-glucan composition including 1 g/L of the refined beta-glucan and having the specified relationship between temperature, salinity, and Filterability Ratio, can have any suitable pH, such as a pH of 7, about 2 to about 11, about 5 to about 10, or about 2 or less, or less than, equal to, or greater than about 2.5, 3, 3.5, 4, 4.5, 5, 5.5, 6, 6.5, 7, 7.5, 8, 8.5, 9, 9.5, 10, 10.5, or about 11 or more. At pH above 11, the molecular structure of the refined beta-glucan can be degraded.

The Filterability Ratio can be determined by the procedure described in the Examples. The Filterability Ratio indicates the degree to which the mixture causes pore clogging over time, and is a ratio of time required for 20 g flow at a steady pressure through a filter at a later time divided by the time required for 20 g flow through the filter at an earlier time, with a ratio of 1 indicating no pore clogging (e.g., equal times required for flow at later and earlier times through the same filter at the same pressure). The Filterability Ratio can be determined by passing the sample through a filter having a pore size of about 1.2 microns (e.g., 47 mm diameter, 1.2 μm pore size, EMD Millipore mixed cellulose esters filter (part #RAWP04700)) using a pressure to achieve a flux of about 1-3 g/s and maintaining such pressure consistently while measuring the mass of filtrate produced. The Filterability Ratio is (time (180 g)−time (160 g))/(time (80 g)−time (60 g)). Prior to passing the sample through the 1.2 micron filter, the sample can first be optionally passed through a filter having a pore size of about 2 microns (e.g., 47 mm diameter Millipore AP25 filter (AP2504700)) at about 100-300 mL/min. The sample can optionally be prepared by combining powdered refined beta-glucan with water in a concentration of 1 g/L, mixing at 700 rpm for 20 minutes, and then agitating at 2,000 rpm for 4 hours.

The refined beta-glucan can be sufficient such that an aqueous beta-glucan composition including 1 g/L of the refined beta-glucan, having a salinity of 35,000 ppm TDS, and having a temperature of at least 40° C., or at least 22° C. (e.g., 22° C. to 140° C., or 40° C. to 140° C., or 10° C. or less, or less than, equal to, or greater than 11° C., 12, 13, 14, 15, 16, 17, 18, 19, 20, 21, 22, 23, 24, 25, 26, 27, 28, 29, 30, 31, 32, 33, 34, 35, 36, 37, 38, 39, 40, 42, 44, 46, 48, 50, 52, 54, 56, 58, 60, 65, 70, 75, 80, 85, 90, 95, 100, 105, 110, 115, 120, 125, 130, 135° C., or about 140° C. or more), has a Filterability Ratio of less than 2, or less than 1.2 (e.g., less than 2 and greater than 1, less than 2 and greater than or equal to 1.2, less than 2 and greater than 1, 1.05 to 1.2, 1.05 to 1.15, 1.05 to 1.10, or less than, equal to, or greater than about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.35, 1.4, 1.45, 1.5, 1.55, 1.6, 1.65, 1.7, 1.75, 1.8, 1.85, 1.9, 1.95, or about 2 or more).

The refined beta-glucan can be sufficient such that an aqueous beta-glucan composition including 1 g/L of the refined beta-glucan, having a salinity of 60,000 ppm TDS or less, and having a temperature of at least 40° C., or at least 30° C. (e.g., 40° C. to 140° C., 30° C. to 140° C., or 20° C. or less, or less than, equal to, or greater than 21° C., 22, 23, 24, 25, 26, 27, 28, 29, 30, 31, 32, 33, 34, 35, 36, 37, 38, 39, 40, 41, 42, 43, 44, 45, 46, 47, 48, 49, 50, 52, 54, 56, 58, 60, 62, 64, 66, 68, 70, 75, 80, 85, 90, 95, 100, 105, 110, 115, 120, 125, 130, 135° C., or about 140° C. or more), has a Filterability Ratio of less than 2, or less than 1.2 (e.g., less than 2 and greater than 1, less than 2 and greater than or equal to 1.2, less than 2 and greater than 1, 1.05 to 1.2, 1.05 to 1.15, 1.05 to 1.10, or less than, equal to, or greater than about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.35, 1.4, 1.45, 1.5, 1.55, 1.6, 1.65, 1.7, 1.75, 1.8, 1.85, 1.9, 1.95, or about 2 or more).

The refined beta-glucan can be sufficient such that an aqueous beta-glucan composition including 1 g/L of the refined beta-glucan, having a salinity of 100,000 ppm TDS or less, at a temperature of at least 50° C., or at least 40° C. (e.g., 40° C. to 140° C., 50° C. to 140° C., or 30° C. or less, or less than, equal to, or greater than 31° C., 32, 33, 34, 35, 36, 37, 38, 39, 40, 41, 42, 43, 44, 45, 46, 47, 48, 49, 50, 51, 52, 53, 54, 55, 56, 57, 58, 59, 60, 62, 64, 66, 68, 70, 75, 80, 85, 90, 95, 100, 105, 110, 115, 120, 125, 130, 135° C., or about 140° C. or more), has a Filterability Ratio of less than 2, less than 2 and greater than or equal to 1.2, or less than 1.2 (e.g., less than 2 and greater than 1, less than 2 and greater than or equal to 1.2, less than 2 and greater than 1, 1.05 to 1.2, 1.05 to 1.15, 1.05 to 1.10, or less than, equal to, or greater than about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.35, 1.4, 1.45, 1.5, 1.55, 1.6, 1.65, 1.7, 1.75, 1.8, 1.85, 1.9, 1.95, or about 2 or more).

The refined beta-glucan can be sufficient such that an aqueous beta-glucan composition including 1 g/L of the refined beta-glucan, having a salinity of 180,000 ppm TDS or less, and having a temperature of at least 60° C., or at least 50° C. (e.g., 50° C. to 140° C., 60° C. to 140° C., or 45° C. or less, or less than, equal to, or greater than 46° C., 47, 48, 49, 50, 51, 52, 53, 54, 55, 56, 57, 58, 59, 60, 65, 70, 75, 80, 85, 90, 95, 100, 105, 110, 115, 120, 125, 130, 135° C., or about 140° C. or more), has a Filterability Ratio of less than 2, or less than 1.2 (e.g., less than 2 and greater than 1, less than 2 and greater than or equal to 1.2, less than 2 and greater than 1, 1.05 to 1.2, 1.05 to 1.15, 1.05 to 1.10, or less than, equal to, or greater than about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.35, 1.4, 1.45, 1.5, 1.55, 1.6, 1.65, 1.7, 1.75, 1.8, 1.85, 1.9, 1.95, or about 2 or more).

The refined beta-glucan can be sufficient such that an aqueous beta-glucan composition including 1 g/L of the refined beta-glucan, having a salinity of 200,000 ppm TDS or less, and having a temperature of at least 67° C., or at least 55° C. (e.g., 55° C. to 140° C., or 67° C. to 140° C., or 45° C. or less, or less than, equal to, or greater than 46° C., 47, 48, 49, 50, 51, 52, 53, 54, 55, 56, 57, 58, 59, 60, 61, 62, 63, 64, 65, 66, 67, 68, 69, 70, 75, 80, 85, 90, 95, 100, 105, 110, 115, 120, 125, 130, 135° C., or about 140° C. or more), has a Filterability Ratio of less than 2, or less than 1.2 (e.g., less than 2 and greater than 1, less than 2 and greater than or equal to 1.2, less than 2 and greater than 1, 1.05 to 1.2, 1.05 to 1.15, 1.05 to 1.10, or less than, equal to, or greater than about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.35, 1.4, 1.45, 1.5, 1.55, 1.6, 1.65, 1.7, 1.75, 1.8, 1.85, 1.9, 1.95, or about 2 or more).

The refined beta-glucan can be sufficient such that an aqueous beta-glucan composition including 1 g/L of the refined beta-glucan, having a salinity of 213,000 ppm TDS or less, and having a temperature of at least 60° C., or at least 56° C. (e.g., 56° C. to 140° C., or 60° C. to 140° C., or 50° C. or less, or less than, equal to, or greater than 51° C., 52, 53, 54, 55, 56, 57, 58, 59, 60, 61, 62, 63, 64, 65, 66, 67, 68, 69, 70, 75, 80, 85, 90, 95, 100, 105, 110, 115, 120, 125, 130, 135° C., or about 140° C. or more), has a Filterability Ratio of less than 2, or less than 1.2 (e.g., less than 2 and greater than 1, less than 2 and greater than or equal to 1.2, less than 2 and greater than 1, 1.05 to 1.2, 1.05 to 1.15, 1.05 to 1.10, or less than, equal to, or greater than about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.35, 1.4, 1.45, 1.5, 1.55, 1.6, 1.65, 1.7, 1.75, 1.8, 1.85, 1.9, 1.95, or about 2 or more).

The refined beta-glucan can have any suitable relationship between salinity, temperature, and Filterability Ratio. For example, the refined beta-glucan can be sufficient such that an aqueous beta-glucan composition including 1 g/L of the refined beta-glucan, having a salinity of greater than 0 (e.g., about 1 ppm TDS to about 400,000 ppm TDS, or about 1 ppm or less, or less than, equal to, or greater than about 10 ppm TDS, 20, 50, 100, 150, 200, 250, 500, 750, 1,000, 1,500, 2,500, 5,000, 10,000, 15,000, 20,000, 25,000, 50,000, 75,000, 100,000, 125,000, 150,000, 175,000, 200,000, 250,000, 300,000, 350,000, or about 400,000 ppm TDS or more), and having a temperature of greater than 0° C. (e.g., 1° C. to 140° C., or about 1° C. or less, or less than, equal to, or greater than about 2° C., 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, 75, 80, 85, 90, 95, 100, 105, 110, 115, 120, 125, 130, 135, or about 140° C. or more), has a Filterability Ratio of less than 2, or less than 1.2 (e.g., less than 2 and greater than 1, less than 2 and greater than or equal to 1.2, less than 2 and greater than 1, 1.05 to 1.2, 1.05 to 1.15, 1.05 to 1.10, or less than, equal to, or greater than about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.35, 1.4, 1.45, 1.5, 1.55, 1.6, 1.65, 1.7, 1.75, 1.8, 1.85, 1.9, 1.95, or about 2 or more).

In various aspects, the present invention provides a liquid composition including the refined beta-glucan (e.g., including any suitable proportion of water, such as more than or less than 50 vol %, with the remainder being water-miscible liquids such as one or more of an alcohol, an alpha-hydroxy acid alkyl ester, and a polyalkylene glycol alkyl ether), such as an aqueous beta-glucan composition including the refined beta-glucan (e.g., including at least 50 vol % water). The aqueous beta-glucan composition can include any suitable amount of the refined beta-glucan, can have any salinity, temperature, and Filterability Ratio, so long as the refined beta-glucan can be used to form an aqueous beta-glucan composition having a concentration of 1 g/L and having the specified relationship between salinity, temperature, and Filterability Ratio. The liquid composition, such as the aqueous beta-glucan composition, can be a liquid for treating a subterranean formation (e.g., for enhanced oil recovery polymer flooding, for hydraulic fracturing, water shut-off, conformance, or a combination thereof), or a concentrated liquid designed to be diluted to form a liquid for treating a subterranean formation.

The liquid of the aqueous beta-glucan composition can be any suitable vol % water, such as about 100 vol % water, or about 51% to about 100 vol % water, or about 51 vol % or more water, or less than, equal to, or greater than about 55 vol %, 60, 65, 70, 75, 80, 82, 84, 86, 88, 90, 91, 92, 93, 94, 95, 96, 97, 98, 99, 99.9, 99.99 vol %, or about 99.999 vol % or more water. The water can be any suitable water, such as fresh water, salt water, brine, produced water, flowback water, brackish water, sea water, synthetic sea water, or a combination thereof. For a salt water, the one or more salts therein can be any suitable salt, such as at least one of NaBr, CaCl₂, CaBr₂, ZnBr, KCl, NaCl, a carbonate salt, a sulfonate salt, sulfite salts, sulfide salts, a phosphate salt, a phosphonate salt, a magnesium salt, a sodium salt, a calcium salt, a bromide salt, a formate salt, an acetate salt, a nitrate salt, or a combination thereof. The water can have any suitable total dissolved solids level, such as about 1,000 mg/L to about 250,000 mg/L, or about 1,000 mg/L or less, or about 0 mg/L, or about 5,000 mg/L, 10,000, 15,000, 20,000, 25,000, 30,000, 40,000, 50,000, 75,000, 100,000, 125,000, 150,000, 175,000, 200,000, 225,000, or about 250,000 mg/L or more. The water can have any suitable salt concentration, such as about 1,000 ppm to about 300,000 ppm, or about 1,000 ppm to about 150,000 ppm, or about 0 ppm, or about 1,000 ppm or less, or about 5,000 ppm, 10,000, 15,000, 20,000, 25,000, 30,000, 40,000, 50,000, 75,000, 100,000, 125,000, 150,000, 175,000, 200,000, 225,000, 250,000, 275,000, or about 300,000 ppm or more. In some examples, the water can have a concentration of at least one of NaBr, CaCl₂, CaBr₂, ZnBr, KCl, and NaCl of about 0.1% w/v to about 20% w/v, or about 0%, or about 0.1% w/v or less, or about 0.5% w/v, 1, 2, 3, 4, 5, 6, 7, 8, 9, 10, 11, 12, 13, 14, 15, 16, 17, 18, 19, 20, 21, 22, 23, 24, 25, 26, 27, 28, 29, or about 30% w/v or more.

The aqueous beta-glucan composition can include water-miscible fluids such as an alcohol, an alpha-hydroxy acid alkyl ester, a polyalkylene glycol alkyl ether, or a combination thereof, which can be about 0 vol % to about 49 vol % of the liquid of the aqueous beta-glucan composition. The aqueous beta-glucan composition can be formed from the refined beta-glucan by suitably homogenizing the refined beta-glucan in the liquid, such as by applying shear thereto. In some aspects, the composition is sheared until the viscosity of the composition is approximately equal to the ultimate viscosity of the composition.

The aqueous beta-glucan composition can have any suitable concentration of the refined beta-glucan. The aqueous beta-glucan composition can include one refined beta-glucan or more than one refined beta-glucan. The aqueous beta-glucan composition can optionally include one or more unrefined beta-glucans or other materials in addition to the one or more refined beta-glucans. The one or more refined beta-glucans can be about 0.001 wt % to about 99.999 wt % of the aqueous beta-glucan composition, or about 0.001 wt % or less, or less than, equal to, or greater than about 0.01 wt %, 0.1, 1, 2, 3, 4, 5, 6, 8, 10, 12, 14, 16, 18, 20, 25, 30, 35, 40, 45, 50, 55, 60, 65, 70, 75, 80, 85, 90, 91, 92, 93, 94, 95, 96, 97, 98, 99, 99.9, 99.99, or about 99.999 wt % or more. The aqueous beta-glucan composition can have a concentration of the one or more refined beta-glucans of about 30 ppm (wherein all ppm herein indicate ppmw unless otherwise indicated) to about 3,000 ppm, or about 400 ppm to about 1,500 ppm, or about 30 ppm or less, or less than, equal to, or greater than about 40 ppm, 50, 60, 70, 80, 90, 100, 120, 140, 160, 180, 200, 250, 300, 350, 400, 450, 500, 600, 700, 800, 900, 1,000, 1,250, 1,500, 1,750, 2,000, 2,250, 2,500, 2,750, or about 3,000 ppm or more.

The aqueous beta-glucan composition can have any suitable temperature, such as about 0° C. to about 140° C., about 60° C. to 110° C., about 0° C. or less, or less than, equal to, or greater than about 2° C., 4, 6, 8, 10, 12, 14, 16, 18, 20, 25, 30, 35, 40, 45, 50, 55, 60, 65, 70, 75, 80, 85, 90, 95, 100, 105, 110, 115, 120, 125, 130, 135, or about 140° C. or more.

The aqueous beta-glucan composition can have any suitable salinity, such as about 0 ppm TDS to 400,000 ppm TDS, about 35,000 ppm TDS to about 220,000 ppm TDS, or about 1 ppm or less, or less than, equal to, or greater than about 10 ppm TDS, 20, 50, 100, 150, 200, 250, 500, 750, 1,000, 1,500, 2,500, 5,000, 10,000, 15,000, 20,000, 25,000, 50,000, 75,000, 100,000, 125,000, 150,000, 175,000, 200,000, 250,000, 300,000, 350,000, or about 400,000 ppm TDS or more.

### Method of Maintaining the Filterability Ratio of an Aqueous Beta-Glucan Composition.

In various aspects, the present invention provides a method of maintaining a Filterability Ratio of an aqueous beta-glucan composition. The method can be a method of placing the aqueous beta-glucan composition in a suitable location, such as a subterranean location, such that the aqueous beta-glucan composition has a Filterability Ratio of less than 2, or less than 1.2. The aqueous beta-glucan composition is predominantly water (e.g., 51 vol % or more) and includes any suitable concentration of any one or more beta-glucans that can be used to perform the method (e.g., that can achieve the specified Filterability Ratio, such as that can achieve a Filterability Ratio of less than 2, or less than 1.2, during the method), such as one or more of the refined beta-glucans described herein, one or more other beta-glucans, or a combination thereof. As used herein, a Filterability Ratio can be maintained or controlled if it is achieved for any duration of time, regardless of the Filterability Ratio of the composition prior to or after the duration of time, such as for a fraction of a second, several hours, days, or weeks, such as for about 0.001 s or less, or about 1 s or more, or less than, equal to, or greater than about 10 s, 20 s, 30 s, 1 min, 2, 5, 10, 15, 20, 30, 45 min, 1 h, 2, 3, 4, 5, 6, 8, 10, 15, 20 h, or about 1 d or more.

The method can include controlling temperature of the aqueous beta-glucan composition, salinity of the aqueous beta-glucan composition, or a combination thereof, such that the Filterability Ratio of the aqueous beta-glucan composition is less than 2, or less than 1.2, such as less than 2 and greater than 1, less than 2 and greater than or equal to 1.2, less than 2 and greater than 1, 1.05 to 1.2, 1.05 to 1.15, 1.05 to 1.10, or less than, equal to, or greater than about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.35, 1.4, 1.45, 1.5, 1.55, 1.6, 1.65, 1.7, 1.75, 1.8, 1.85, 1.9, 1.95, or about 2 or more. Controlling the temperature of the aqueous beta-glucan composition can include applying heat to the aqueous beta-glucan composition, such as either to maintain the temperature thereof, to raise the temperature thereof, or to slow the decrease of the temperature thereof. Controlling the temperature of the aqueous beta-glucan composition can include adding water to the aqueous beta-glucan composition having a lower, equal, or higher salinity as compared to the salinity of the aqueous beta-glucan composition prior to addition of the water, which can result in lowering, maintaining, or raising the salinity of the aqueous beta-glucan composition. The controlling of the temperature or salinity of the aqueous beta-glucan composition can maintain or decrease the Filterability Ratio, such as to the specified levels.

Controlling the temperature or salinity of the aqueous beta-glucan composition can be performed at any suitable time or location. For example, controlling the temperature or salinity of the aqueous beta-glucan composition can be performed above-surface, in a subterranean formation, or a combination thereof.

Controlling temperature of the aqueous beta-glucan composition can include maintaining or changing the temperature of the aqueous beta-glucan such that it reaches or is maintained at a predetermined temperature, such as a temperature within a temperature range, such as about 0° C. to about 140° C., about 60° C. to 110° C., about 0° C. or less, or less than, equal to, or greater than about 2° C., 4, 6, 8, 10, 12, 14, 16, 18, 20, 25, 30, 35, 40, 45, 50, 55, 60, 65, 70, 75, 80, 85, 90, 95, 100, 105, 110, 115, 120, 125, 130, 135, or about 140° C. or more. Maintaining or changing the temperature of the aqueous beta-glucan can include heating the aqueous beta-glucan composition such that the temperature is maintained or increased, or such that a temperature decrease thereof is slowed. Heating can include directly heating the aqueous beta-glucan composition, or heating indirectly by heating a tubular (e.g., any suitable type of oilfield pipe, such as pipeline, drill pipe, production tubing, and the like) or subterranean formation prior to, during, or after placing the aqueous beta-glucan composition into the tubular or subterranean formation. Heating a subterranean formation can include heating equipment in the subterranean formation, such as tubulars or other equipment disposed therein. Achieving or maintaining the predetermined temperature of the aqueous beta-glucan composition can be sufficient such that the aqueous beta-glucan composition has a Filterability Ratio of less than 2, or less than 1.2, such as less than 2 and greater than 1, less than 2 and greater than or equal to 1.2, less than 2 and greater than 1, 1.05 to 1.2, 1.05 to 1.15, 1.05 to 1.10, or less than, equal to, or greater than about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.35, 1.4, 1.45, 1.5, 1.55, 1.6, 1.65, 1.7, 1.75, 1.8, 1.85, 1.9, 1.95, or about 2 or more.

Controlling salinity of the aqueous beta-glucan composition can include changing or maintaining the salinity of the aqueous beta-glucan composition such that the salinity of the aqueous beta-glucan composition reaches or is maintained at a predetermined salinity, such as within a salinity range, such as about 1 ppm TDS to 400,000 ppm TDS, about 35,000 ppm TDS to about 220,000 ppm TDS, or about 1 ppm or less, or less than, equal to, or greater than about 10 ppm TDS, 20, 50, 100, 150, 200, 250, 500, 750, 1,000, 1,500, 2,500, 5,000, 10,000, 15,000, 20,000, 25,000, 50,000, 75,000, 100,000, 125,000, 150,000, 175,000, 200,000, 250,000, 300,000, 350,000, or about 400,000 ppm TDS or more. Controlling salinity of the aqueous beta-glucan composition can include adding water thereto having a lower, equal, or greater salinity as compared to the salinity of the aqueous beta-glucan composition prior to the addition of the water thereto. Controlling salinity can include directly adding a liquid to the aqueous beta-glucan composition, or adding a liquid indirectly such as by placing the diluting liquid in a tubular or subterranean formation prior to, during, or after placing the aqueous beta-glucan composition into the tubular or subterranean formation. Controlling salinity of a subterranean formation can include changing the salinity of equipment in the subterranean formation, such as tubulars or other equipment disposed therein. Controlling salinity can include diluting the aqueous beta-glucan composition with water having a lower salinity as compared to the aqueous beta-glucan composition, such as with fresh water, salt water, brine, produced water, flowback water, brackish water, sea water, synthetic sea water, or a combination thereof. Achieving or maintaining the predetermined salinity of the aqueous beta-glucan composition can be sufficient such that the aqueous beta-glucan composition has a Filterability Ratio of less than 2, or less than 1.2, such as less than 2 and greater than 1, less than 2 and greater than or equal to 1.2, less than 2 and greater than 1, 1.05 to 1.2, 1.05 to 1.15, 1.05 to 1.10, or less than, equal to, or greater than about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.35, 1.4, 1.45, 1.5, 1.55, 1.6, 1.65, 1.7, 1.75, 1.8, 1.85, 1.9, 1.95, or about 2 or more.

The aqueous beta-glucan composition can have any suitable concentration of the refined beta-glucan during performance of the method, such as about 30 ppm to about 3,000 ppm, about 400 ppm to about 3,000 ppm, or about 30 ppm or less, or less than, equal to, or greater than about 40 ppm, 50, 60, 70, 80, 90, 100, 120, 140, 160, 180, 200, 250, 300, 350, 400, 450, 500, 600, 700, 800, 900, 1,000, 1,250, 1,500, 1,750, 2,000, 2,250, 2,500, 2,750, or about 3,000 ppm or more.

The method can be a method of treating a subterranean formation that includes placing the aqueous beta-glucan composition in the subterranean formation. Controlling temperature or salinity during a method treatment of a subterranean formation can occur prior to, during, or after placing the aqueous beta-glucan composition in the subterranean formation, or a combination thereof. Controlling of the temperature or salinity of the aqueous beta-glucan composition can include placing the aqueous beta-glucan composition in the subterranean formation and allowing the temperature or salinity of the subterranean formation to change or maintaining the temperature or salinity of the aqueous beta-glucan composition. Controlling of temperature or salinity of the aqueous beta-glucan composition can include modifying temperature or salinity of the aqueous beta-glucan composition prior to or during the placing of the aqueous beta-glucan composition in the subterranean formation, modifying temperature or salinity of the subterranean formation prior to or during the placing of the aqueous beta-glucan composition in the subterranean formation such that the temperature or salinity of the subterranean formation changes or maintains the temperature or salinity of the aqueous beta-glucan composition, or a combination thereof. The method of treating a subterranean formation can include enhanced oil recovery polymer flooding, hydraulic fracturing, or a combination thereof. During a method of treating the subterranean formation, for at least some duration of time while the aqueous beta-glucan composition is in the subterranean formation, the aqueous beta-glucan composition can have a Filterability Ratio of less than 2, or less than 1.2 (e.g., less than 2 and greater than 1, less than 2 and greater than or equal to 1.2, less than 2 and greater than 1, 1.05 to 1.2, 1.05 to 1.15, 1.05 to 1.10, or less than, equal to, or greater than about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.35, 1.4, 1.45, 1.5, 1.55, 1.6, 1.65, 1.7, 1.75, 1.8, 1.85, 1.9, 1.95, or about 2 or more). The duration of time can be any suitable duration of time, such as about 0.001 s or less, or about 1 s or more, or less than, equal to, or greater than about 10 s, 20 s, 30 s, 1 min, 2, 5, 10, 15, 20, 30, 45 min, 1 h, 2, 3, 4, 5, 6, 8, 10, 15, 20 h, or about 1 d or more.

In various aspects, the method can include heating the subterranean formation (e.g., the formation itself and/or equipment therein such as tubulars) using a heated injection fluid during or prior to placement of the aqueous beta-glucan composition in the subterranean formation. The method can include heating a tubular in the subterranean formation prior to or during injecting the aqueous beta-glucan composition through the tubular to place the aqueous beta-glucan composition in the subterranean formation. Heating of a tubular can occur via flowing a heated liquid through a flowpath in or around the tubular (e.g., in the annulus outside the tubular or inside the tubular. Heating of a tubular can include reducing a flow rate of a fluid in the tubular to increase a temperature of the tubular prior to or during injecting the aqueous beta-glucan composition through the tubular to place the aqueous beta-glucan composition in the subterranean formation.

In various aspects, controlling the salinity of the aqueous beta-glucan composition can include injecting a diluting fluid into the subterranean formation before, during, or after placement of the aqueous beta-glucan composition in the subterranean formation. The aqueous beta-glucan composition is then diluted by the diluting fluid during or after transit to the subterranean formation to control the salinity thereof.

Prior to placing in the subterranean formation, the aqueous beta-glucan composition can have any suitable Filterability Ratio, such as a Filterability Ratio of less than 2 (e.g., less than 2 or less than 1.2), or a Filterability Ratio of greater than 2 (e.g., greater than 2 or greater than 1.2). In some aspects, the aqueous beta-glucan composition has a Filterability Ratio of less than 2 or less than 1.2 prior to placing in the subterranean formation and has a Filterability Ratio of less than 2 or less than 1.2 for at least some duration of time after placing it in the subterranean formation. In some aspects, the aqueous beta-glucan composition has a Filterability Ratio greater than 2 or greater than 1.2 prior to placing in the subterranean formation (e.g., greater than 2, or greater than 1.2) and achieves a Filterability Ratio less than 2 or less than 1.2 after placing it in the subterranean formation, such as due to heating of the composition, dilution of the composition, or a combination thereof, that occurs during or after placement in the subterranean formation.

Placing the aqueous beta-glucan composition in the subterranean formation and allowing the temperature or salinity of the subterranean formation to change or maintaining the temperature or salinity of the aqueous beta-glucan composition can include allowing the aqueous beta-glucan composition to be modified to acquire the natural or native salinity or temperature of the subterranean formation. In some aspects, placing the aqueous beta-glucan composition in the subterranean formation and allowing the temperature or salinity of the subterranean formation to change or maintaining the temperature or salinity of the aqueous beta-glucan composition can include modifying at the salinity, the temperature, or a combination thereof, of the subterranean formation or a tubular connected thereto prior to placing the aqueous beta-glucan composition in the subterranean formation.

Controlling the temperature or salinity of the aqueous beta-glucan composition so that the aqueous beta-glucan composition has a Filterability Ratio of less than 2, or less than 1.2 (e.g., less than 2 and greater than 1, less than 2 and greater than or equal to 1.2, less than 2 and greater than 1, 1.05 to 1.2, 1.05 to 1.15, 1.05 to 1.10, or less than, equal to, or greater than about 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.2, 1.21, 1.22, 1.23, 1.24, 1.25, 1.26, 1.27, 1.28, 1.29, 1.3, 1.35, 1.4, 1.45, 1.5, 1.55, 1.6, 1.65, 1.7, 1.75, 1.8, 1.85, 1.9, 1.95, or about 2 or more), is performed at least one of prior to, during, and after the placing of the aqueous beta-glucan composition in the subterranean formation.

The subterranean formation can have any suitable pH, such as before or after pH modification, such as about 5 to about 10, or about 6.5 to about 8.5, or about 2 or less, or less than, equal to, or greater than about 2.5, 3, 3.5, 4, 4.5, 5, 5.5, 6, 6.5, 7, 7.5, 8, 8.5, 9, 9.5, 10, 10.5, or about 11 or more. At a pH of about 11 or more, the chemical structure of the refined beta-glucan can degrade.

The subterranean formation can have any suitable temperature, such as about 0° C. to about 140° C., or about 60° C. to about 110° C., or about 0° C. or less, or less than, equal to, or greater than about 5° C., 10, 15, 20, 25, 30, 35, 40, 45, 50, 55, 60, 65, 70, 75, 80, 85, 90, 95, 100, 105, 110, 115, 120, 125, 130, 135, 140, 145, or about 150° C. or more.

The method of treating the subterranean formation can include performing an enhanced oil recovery procedure in the subterranean formation using the aqueous beta-glucan composition. The enhanced oil recovery procedure can include polymer flooding. The method can include using the aqueous beta-glucan composition placed in the subterranean formation to sweep petroleum in the subterranean formation toward a well (e.g., a different well from a well the aqueous beta-glucan composition was originally placed in). The method can include removing the petroleum from the well (e.g., at least some of the petroleum that was swept toward the well).

### EXAMPLES

Various aspects of the present invention can be better understood by reference to the following Examples which are offered by way of illustration. The present invention is not limited to the Examples given herein.

The term “ambient conditions” as used in the Examples refers to about 18° C. to about 22° C. and about 96 kPa to about 103 kPa. All Examples were performed under ambient conditions unless otherwise indicated.

Part I. Beta-Glucan Preparation.

### Example I-1. Beta-Glucan Preparation from Commercial Material

Using a 5000 liter jacketed vessel with moderate agitation, 7 g/L of commercial Actigum® CS6 from Cargill (crude powder blend of scleroglucan and sclerotium rolfsii organism powder) was added to 2400 liters of 11.8° C. water and mixed for 1 hour. After an hour of mixing, the vessel was heated to 85° C. and left under agitation for 12 hours without temperature control. After 12 hours the temperature was 41.3° C. and the vessel was reheated to 80° C. and passed through a Guerin homogenizer at 200 bar of pressure and 300 L/hr.

The homogenized mixture was cooled to 50° C. 4 g/L of CaCl₂*2H₂O was added. pH was reduced to 1.81 using 20% HCl. This mixture was agitated for 30 minutes to enable precipitation of oxalic acid (i.e., as the calcium salt thereof, calcium oxalate).

After maturation, the solution was adjusted back to 5.62 pH using 10% Na₂CO₃ and heated to 85° C. and left under agitation without temperature control for 14 hours, then reheated to 80° C.

After reaching 80° C. 20 g/L of Dicalite 4158 filter aid (water permeability 1.4 Darcies to 3.8 Darcies) was added to the vessel and mixed for 10 minutes.

After mixing, the solution was fed to a clean Choquenet 12 m² press filter with Sefar Fyltris 25080 AM filter cloths at 1400 L/hr recycling the product back to the feed tank for 10 minutes. The pore size of the filter cloths was sufficient to prevent passage of the filter aid. At the end of recycle, the flow was adjusted to 1300 L/hr and passed through the filter. Once the tank was empty an additional 50 liters of water was pushed into the filter. The fluid from this water flush and a 12 bar compression of the cake were both added to the collected permeate. The filter was cleaned after use.

The filtered permeate, water flush, and compression fluid was agitated and heated back to 80° C.

The heated mixture had 6 kg of Dicalite 4158 added thereto and was mixed for 10 minutes. At 1400 L/hr this solution was recycled through a clean Choquenet 12 m² press filter with Sefar Fyltris 25080 AM filter cloths at 1400 L/hr for 15 minutes. After the recycle, the tank was passed through the filter at 1400 L/hr.

Without cleaning the filter, 5.33 g/L of Clarcel® DICS (water permeability 2.4 Darcies to 4.0 Darcies) and 6.667 g/L of Clarcel® CBL (water permeability 0.049 Darcies to 0.101 Darcies) were added to the mixture and agitation was performed for one hour while maintaining the temperature at 80° C. This mixture was then recycled through the Dicalite coated Choquenet 12 m² press filter with Sefar Fyltris 25080 AM filter cloths at 1400 L/hr for 15 minutes. After the recycle, the tank was passed through the filter at 1350 L/hr. An additional 50 liters of flush water were pushed through the filter and permeate was collected as well. Compression fluid from the filter was not captured.

This twice filtered material was heated to 85° C. and left agitated without temperature control for 14 hours. At this point the material was reheated to 80° C. for a third filtration step.

The heated mixture had 6 kg of Dicalite 4158 added thereto and mixing was performed for 10 minutes. At 1400 L/hr this solution was recycled through a clean Choquenet 12 m² press filter with Sefar Fyltris 25080 AM filter cloths at 1400 L/hr for 15 minutes. After the recycle, the tank was passed through the filter at 1450 L/hr.

Without cleaning the filter, 5.33 g/L of Clarcel® DICS and 6.667 g/L of Clarcel® CBL were added to the mixture and agitation was performed for one hour while maintaining the temperature at 80° C. This mixture was then recycled through the Dicalite coated Choquenet 12 m² press filter with Sefar Fyltris 25080 AM filter cloths at 1600 L/hr for 15 minutes. After the recycle, the tank was passed through the filter at 1700 L/hr. An additional 50 liters of flush water was pushed through the filter and permeate was collected as well. Compression fluid from the filter was not captured.

The triple filtered permeate was cooled to 60° C. and mixed with 83% IPA at a 1:2 ratio, 2 g IPA solution for each g of scleroglucan solution. This precipitated scleroglucan fibers which can be mechanically separated from the bulk solution. In this example, a tromel separator was used to partition the precipitated fibers from the bulk liquid solution.

After recovery of the fibers they were washed with another 0.5 g 83% IPA solution for each 1 g of initial triple filtered permeate scleroglucan solution.

Wash fibers were dried in an ECI dryer with 95° C. hot water for 1 hour and 13 minutes to produce a product with 88.64% dry matter. This material was ground up and sieved to provide powder smaller in size than 250 micron. The final ground scleroglucan material was Sample 1 used in Part II herein.

### Part II. Properties of Aqueous Beta-Glucan Compositions at Various Temperatures and Salinities.

Filterability Ratio determination. At ambient conditions, water (250 mL) was added to a VWR1213-1173 Borosilicate glass 3.3 400 mL beaker. While agitating the water using an IKA RW20 DZM stirrer at 700 rpm, Sample 1 (0.25 g+/−0.1 g) was sprinkled into the beaker onto the wall of the vortex. During the agitation, the center of the bottom of the shaft was located 2 cm above the center of the bottom of the beaker. The contents of the beaker were agitated for 20 minutes to incorporate the solids and build some viscosity before increasing agitation. The agitation was increased to 2,000 rpm, and agitation was performed for 4 hours.

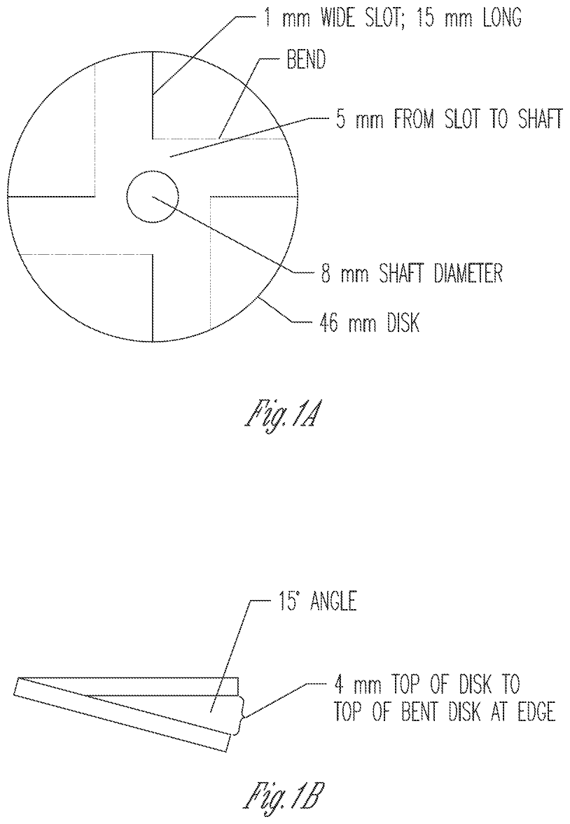

The shaft and mixing element used on the IKA RW20 DZM stirrer is shown in FIGS. 1A-B and have the following geometry. An 8 mm diameter shaft has a 46 mm diameter disc 1 mm thick welded to the bottom of shaft. The disc has four 1 mm slots cut at 90 degrees from each other. They extend from the exterior of the disc to within 5 mm of the end of the shaft. In the clockwise direction the side of the slot on the disk is bent downwards 4 mm (as measured from the top of the disc to top of the disk at the outer edge of disk) with the fold making a right angle with the slot and commencing at the base of the slot and extending to the edge of the disc. The descent angle at the fold is about 15 degrees. FIG. 1A illustrates a top view of the stirrer. FIG. 1B illustrates a side view of one of the four bends of the stirrer, as viewed perpendicularly to one the slot adjacent to the bend.

The subsequent filtration testing is carried out within one hour of solubilization before any microbe formation in the solution can negatively impact the Filterability Ratio. A Pall stainless steel filter housing (4280) was assembled with a 47 mm diameter Millipore AP25 filter (AP2504700), having a pore size of 2 microns. For each sample tested, the dispersion was passed through the housing using a flow rate of 100-300 mL/min, and the filtered dispersion was used for future steps. The Pall stainless steel filter housing (4280) was assembled with 47 mm diameter, 1.2 μm pore size, EMD Millipore mixed cellulose esters filter (part #RAWP04700), with >200 mL of solution. A container was placed on a mass balance for recording mass of material passing through the filter. Pressure was applied to the filter. The filter was unplugged and pressure was adjusted to achieve a target flux of 1-3 g/s. Once target flux was established, a constant pressure was maintained and the time needed to filter 60 g, 80 g, 160 g, and 180 g of solution through the filter was measured. Filterability Ratio was determined as (time (180 g)−time (160 g))/(time (80 g)−time (60 g)). The elapsed time between the assembly of the Pall stainless steel filter with >200 mL of solution and the time to complete the passing of the 180 g solution through the filter took between 30 minutes and 4 hours.

### Example II-1. Filterability Ratio at Various Temperatures and Salinities

Sample 1 from Part I was used to generate aqueous solutions having a concentration of beta-glucan of 1 g/L and having various salinities. The solutions had a pH of 7. The brines used to form the solutions had compositions that mirrored the ratio of divalent ions in sea salt (the 35 g/L TDS included 1.7 g/L divalent ions, and the 60, 100, 200, and 213 g/L TDS brines had the same proportion of divalent ions) except the 180 g/L TDS brine used 17.67 g/L divalent ions and the 184 g/L TDS used 16.4 g/L divalent ions.

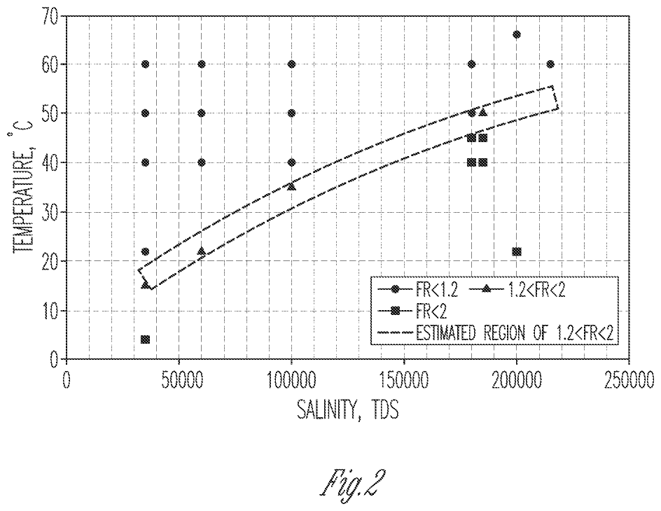

The Filterability Ratios of the aqueous solutions was tested at various temperatures. The results are given in FIG. 2, with circles indicating a filterability ratio of less than 1.2, triangles indicating a filterability ratio of greater than 1.2 and less than 2, and with crosses indicating a filterability ratio of 2 or more.

### Example II-2. Effect of pH Variation on Filterability Ratio

Various data points from Example II-1 were re-measured using aqueous beta-glucan compositions having a pH between 4 and 10. Little to no shift was observed in the temperature and salinity conditions needed to achieve a Filterability Ratio of less than 2 or less than 1.2 across various temperatures and salinities.

### Example II-3. Effect of Concentration on Filterability Ratio

Various data points from Example II-1 were re-measured using a beta-glucan concentration of 100 ppm to 2,000 ppm. Little to no shift was observed in the temperature and salinity conditions needed to achieve a Filterability Ratio of less than 2 or less than 1.2 across various temperatures and salinities. Higher concentration samples were observed to foul the filter more quickly than lower concentration samples.

### Example II-4. Effect of Ratio of Monovalent Ions to Divalent Ions on Filterability Ratio

Various data points from Example II-1 were re-measured using different ratios of monovalent ions to divalent ions in the brine with little to no shift in the temperature and salinity conditions needed to achieve a Filterability Ratio of less than 2 or less than 1.2 across various temperatures and salinities.

### Example II-5. Effect of Reversal of Temperature or Salinity Conditions on Filterability Ratio

Various data points from Example II-1 were re-measured using temperature and salinity conditions giving Filterability Ratios of greater than 2, and adjusting the temperature or salinity allowed the Filterability Ratio to become less than 2 or less than 1.2 in a way that was consistent with the relationship of temperature and salinity to Filterability Ratio shown in FIG. 2.

### Example II-6. Effect of Variation of Beta-Glucan Purity

Various data points from Example II-1 were re-measured using various other beta-glucans having a Filterability Ratio of less than 1.2 when tested as an aqueous composition with 1 g/L concentration at room temperature and having a TDS of 0 ppm. The other beta-glucans had different ash levels and protein compositions than the beta-glucan of Example I. Little to no shift was observed in the temperature and salinity conditions needed to achieve a Filterability Ratio of less than 2 or less than 1.2 across various temperatures and salinities.

### Example II-7. Comparative Testing

Various data points from Example II-1 were re-measured using commercial Actigum® CS6 from Cargill (crude powder blend of scleroglucan and sclerotium rolfsii organism powder) or commercial Actigum® CS11 from Cargill (clarified scleroglucan powder). Even at low salinity and high temperature, no conditions were identified wherein these samples had Filterability Ratios of less than 2.

The terms and expressions that have been employed are used as terms of description and not of limitation, and there is no intention in the use of such terms and expressions of excluding any equivalents of the features shown and described or portions thereof, but it is recognized that various modifications are possible within the scope of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of the present invention.

### Exemplary Aspects.

The following exemplary Aspects are provided, the numbering of which is not to be construed as designating levels of importance:

Aspect 1 provides a refined beta-glucan that forms an aqueous beta-glucan composition comprising 1 g/L of the refined beta-glucan, the aqueous beta-glucan composition having a salinity of 100,000 ppm TDS or less and having a Filterability Ratio of less than 2 at a temperature of at least 50° C.

Aspect 2 provides the refined beta-glucan of Aspect 1, wherein the refined beta-glucan is in the form of a powder, a liquid concentrate, an aqueous beta-glucan composition having a concentration of the refined beta-glucan of other than 1 g/L, the beta-glucan composition comprising 1 g/L of the refined beta-glucan, or a combination thereof.

Aspect 3 provides the refined beta-glucan of any one of Aspects 1-2, wherein the refined beta-glucan is in the form of the aqueous beta-glucan composition comprising 1 g/L of the refined beta-glucan, having a salinity of 100,000 ppm TDS or less and having a Filterability Ratio of less than 2 at a temperature of at least 50° C.

Aspect 4 provides the refined beta-glucan of any one of Aspects 1-3, wherein the Filterability Ratio is determined by passing a 1 g/L aqueous solution of the refined beta-glucan through a 1.2 micron filter at a consistent pressure sufficient to initially give a flux through the filter at time zero of about 1-3 grams of solution per second, wherein the Filterability Ratio is (time required for 180 g solution to pass through the filter—time required for 160 g solution to pass through the filter)/(time required for 80 g solution to pass through the filter—time required for 60 g of solution to pass through the filter).

Aspect 5 provides the refined beta-glucan of any one of Aspects 1-4, wherein the aqueous beta-glucan composition having a salinity of 100,000 ppm TDS or less has a Filterability Ratio of less than 2 and greater than or equal to 1.2 at a temperature of at least 50° C.

Aspect 6 provides the refined beta-glucan of any one of Aspects 1-5, wherein the aqueous beta-glucan composition having a salinity of 100,000 ppm TDS or less has a Filterability Ratio of less than 1.2 at a temperature of at least 50° C.

Aspect 7 provides the refined beta-glucan of any one of Aspects 1-6, wherein the refined beta-glucan forms an aqueous beta-glucan composition comprising 1 g/L of the refined beta-glucan, the aqueous beta-glucan composition having a salinity of 100,000 ppm TDS or less and having a Filterability Ratio of less than 2, or less than 1.2, at a temperature of at least 40° C.

Aspect 8 provides the refined beta-glucan of any one of Aspects 1-7, wherein the refined beta-glucan forms an aqueous beta-glucan composition comprising 1 g/L of the refined beta-glucan, the aqueous beta-glucan composition having a salinity of 180,000 ppm TDS or less and having a Filterability Ratio of less than 2, or less than 1.2, at a temperature of at least 60° C.

Aspect 9 provides the refined beta-glucan of any one of Aspects 1-8, wherein the refined beta-glucan forms an aqueous beta-glucan composition comprising 1 g/L of the refined beta-glucan, the aqueous beta-glucan composition having a salinity of 180,000 ppm TDS or less and having a Filterability Ratio of less than 2, or less than 1.2, at a temperature of at least 50° C.

Aspect 10 provides the refined beta-glucan of any one of Aspects 1-9, wherein the refined beta-glucan forms an aqueous beta-glucan composition comprising 1 g/L of the refined beta-glucan, the aqueous beta-glucan composition having a salinity of 200,000 ppm TDS or less and having a Filterability Ratio of less than 2, or less than 1.2, at a temperature of at least 67° C.

Aspect 11 provides the refined beta-glucan of any one of Aspects 1-10, wherein the refined beta-glucan forms an aqueous beta-glucan composition comprising 1 g/L of the refined beta-glucan, the aqueous beta-glucan composition having a salinity of 200,000 ppm TDS or less and having a Filterability Ratio of less than 2, or less than 1.2, at a temperature of at least 55° C.

Aspect 12 provides the refined beta-glucan of any one of Aspects 1-11, wherein the refined beta-glucan forms an aqueous beta-glucan composition comprising 1 g/L of the refined beta-glucan, the aqueous beta-glucan composition having a salinity of 213,000 ppm or less and having a Filterability Ratio of less than 2, or less than 1.2, at a temperature of at least 60° C.

Aspect 13 provides the refined beta-glucan of any one of Aspects 1-12, wherein the refined beta-glucan forms an aqueous beta-glucan composition comprising 1 g/L of the refined beta-glucan, the aqueous beta-glucan composition having a salinity of 213,000 ppm or less and having a Filterability Ratio of less than 2, or less than 1.2, at a temperature of at least 56° C.

Aspect 14 provides the refined beta-glucan of any one of Aspects 1-13, wherein the refined beta-glucan forms an aqueous beta-glucan composition comprising 1 g/L of the refined beta-glucan, the aqueous beta-glucan composition having a salinity of 35,000 ppm TDS and having a Filterability Ratio of less than 2, or less than 1.2, at a temperature of at least 40° C.

Aspect 15 provides the refined beta-glucan of any one of Aspects 1-14, wherein the refined beta-glucan forms an aqueous beta-glucan composition comprising 1 g/L of the refined beta-glucan, the aqueous beta-glucan composition having a salinity of 35,000 ppm TDS and having a Filterability Ratio of less than 2, or less than 1.2, at a temperature of at least 22° C.

Aspect 16 provides the refined beta-glucan of any one of Aspects 1-15, wherein the refined beta-glucan forms an aqueous beta-glucan composition comprising 1 g/L of the refined beta-glucan, the aqueous beta-glucan composition having a salinity of 60,000 ppm TDS or less and having a Filterability Ratio of less than 2, or less than 1.2, at a temperature of at least 40° C.

Aspect 17 provides the refined beta-glucan of any one of Aspects 1-16, wherein the refined beta-glucan forms an aqueous beta-glucan composition comprising 1 g/L of the refined beta-glucan, the aqueous beta-glucan composition having a salinity of 60,000 ppm TDS or less and having a Filterability Ratio of less than 2, or less than 1.2, at a temperature of at least 30° C.

Aspect 18 provides the refined beta-glucan of any one of Aspects 1-17, wherein the aqueous beta-glucan composition comprising 1 g/L of the refined beta-glucan has a pH of about 2 to about 11.

Aspect 19 provides the refined beta-glucan of any one of Aspects 1-18, wherein the aqueous beta-glucan composition comprising 1 g/L of the refined beta-glucan has a pH of about 5 to about 10.

Aspect 20 provides an aqueous beta-glucan composition comprising the refined beta-glucan of any one of Aspects 1-19.

Aspect 21 provides the aqueous beta-glucan composition of Aspect 20, wherein the aqueous beta-glucan composition has a concentration of the refined beta-glucan of about 30 ppm to about 3,000 ppm.

Aspect 22 provides the aqueous beta-glucan composition of any one of Aspects 20-21, wherein the aqueous beta-glucan composition has a concentration of the refined beta-glucan of about 400 ppm to about 1,500 ppm.

Aspect 23 provides the aqueous beta-glucan composition of any one of Aspects 20-22, wherein the aqueous beta-glucan composition has a temperature of about 0° C. to about 140° C.

Aspect 24 provides the aqueous beta-glucan composition of any one of Aspects 20-23, wherein the aqueous beta-glucan composition has a temperature of about 60° C. to 110° C.

Aspect 25 provides the aqueous beta-glucan composition of any one of Aspects 20-24, wherein the aqueous beta-glucan composition has a salinity of about 0 ppm TDS to 400,000 ppm TDS.

Aspect 26 provides the aqueous beta-glucan composition of any one of Aspects 20-25, wherein the aqueous beta-glucan composition has a salinity of about 35,000 ppm TDS to about 220,000 ppm TDS.

Aspect 27 provides the aqueous beta-glucan composition of any one of Aspects 1-26.

Aspect 28 provides a refined beta-glucan that forms an aqueous beta-glucan composition comprising 1 g/L of the refined beta-glucan, the aqueous beta-glucan composition having a salinity of 100,000 ppm TDS or less and having a Filterability Ratio of less than 1.2 at a temperature of at least 40° C.

Aspect 29 provides a method of maintaining the Filterability Ratio of the aqueous beta-glucan composition of Aspect 27, the method comprising:

controlling temperature of the aqueous beta-glucan composition, salinity of the aqueous beta-glucan composition, or a combination thereof, such that the Filterability Ratio of the aqueous beta-glucan composition is less than 2.

Aspect 30 provides a method of maintaining a Filterability Ratio of an aqueous beta-glucan composition, the method comprising:

controlling temperature of the aqueous beta-glucan composition, salinity of the aqueous beta-glucan composition, or a combination thereof, such that the Filterability Ratio of the aqueous beta-glucan composition is less than 2.

Aspect 31 provides the method of Aspect 30 wherein the controlling of the temperature or salinity of the aqueous beta-glucan composition is performed above-surface, in a subterranean formation, or a combination thereof.

Aspect 32 provides the method of any one of Aspects 30-31, comprising controlling temperature of the aqueous beta-glucan composition, salinity of the aqueous beta-glucan composition, or a combination thereof, such that the Filterability Ratio of the aqueous beta-glucan composition is less than 2 and greater than or equal to 1.2.

Aspect 33 provides the method of any one of Aspects 30-32, comprising controlling temperature of the aqueous beta-glucan composition, salinity of the aqueous beta-glucan composition, or a combination thereof, such that the Filterability Ratio of the aqueous beta-glucan composition is less than 1.2.

Aspect 34 provides the method of any one of Aspects 30-33, wherein controlling temperature of the aqueous beta-glucan composition comprises maintaining or changing the temperature of the aqueous beta-glucan composition such that it reaches or is maintained at a predetermined temperature.

Aspect 35 provides the method of any one of Aspects 30-34, wherein controlling temperature of the aqueous beta-glucan composition comprises heating the aqueous beta-glucan composition so that the temperature of the aqueous beta-glucan composition reaches or is maintained at a predetermined temperature.

Aspect 36 provides the method of any one of Aspects 34-35, wherein the predetermined temperature is sufficient such that the aqueous beta-glucan composition has a Filterability Ratio of less than 2, or less than 1.2.

Aspect 37 provides the method of any one of Aspects 30-36, wherein controlling salinity of the aqueous beta-glucan composition comprises changing or maintaining the salinity of the aqueous beta-glucan composition such that the salinity of the aqueous beta-glucan composition reaches or is maintained at a predetermined salinity.

Aspect 38 provides the method of any one of Aspects 30-37, wherein controlling salinity of the aqueous beta-glucan composition comprises diluting the aqueous beta-glucan composition such that the salinity of the aqueous beta-glucan composition reaches or is maintained at a predetermined salinity.

Aspect 39 provides the method of any one of Aspects 37-38, wherein the predetermined salinity is sufficient such that the aqueous beta-glucan composition has a Filterability Ratio of less than 2, or less than 1.2.

Aspect 40 provides the method of any one of Aspects 30-39, wherein the refined beta-glucan has a concentration in the aqueous beta-glucan composition of about 30 ppm to about 3,000 ppm.

Aspect 41 provides the method of any one of Aspects 30-40, wherein the refined beta-glucan has a concentration in the aqueous beta-glucan composition of about 400 ppm to about 3,000 ppm.

Aspect 42 provides the method of any one of Aspects 30-41, wherein the method is a method of treating a subterranean formation comprising placing the aqueous beta-glucan composition in a subterranean formation.

Aspect 43 provides the method of Aspect 42, wherein the controlling of the temperature or salinity of the aqueous beta-glucan composition comprises placing the aqueous beta-glucan composition in the subterranean formation and allowing the temperature or salinity of the subterranean formation to change or maintain the temperature or salinity of the aqueous beta-glucan composition.

Aspect 44 provides the method of any one of Aspects 42-43, wherein the controlling of temperature or salinity of the aqueous beta-glucan composition comprises modifying temperature or salinity of the aqueous beta-glucan composition prior to or during the placing of the aqueous beta-glucan composition in the subterranean formation, modifying temperature or salinity of the subterranean formation prior to or during the placing of the aqueous beta-glucan composition in the subterranean formation such that the temperature or salinity of the subterranean formation changes or maintains the temperature or salinity of the aqueous beta-glucan composition, or a combination thereof.

Aspect 45 provides the method of any one of Aspects 42-44, wherein the method of treating a subterranean formation comprises enhanced oil recovery polymer flooding, hydraulic fracturing, or a combination thereof.

Aspect 46 provides the method of any one of Aspects 42-45, wherein controlling the temperature or salinity of the aqueous beta-glucan composition is performed prior to, during, or after the placing of the aqueous beta-glucan composition in the subterranean formation.

Aspect 47 provides the method of any one of Aspects 42-46, wherein the subterranean formation has a temperature or salinity such that after placing the aqueous beta-glucan composition in the subterranean formation the aqueous beta-glucan composition has a Filterability Ratio of less than 2, or less than 1.2.

Aspect 48 provides the method of any one of Aspects 42-47, wherein controlling the temperature or salinity of the aqueous beta-glucan composition so that the aqueous beta-glucan composition has a Filterability Ratio of less than 2, or less than 1.2, is performed prior to, during, or after the placing of the aqueous beta-glucan composition in the subterranean formation.

Aspect 49 provides the method of any one of Aspects 42-48, comprising heating the aqueous beta-glucan composition so that the aqueous beta-glucan composition has a Filterability Ratio of less than 2, or less than 1.2, prior to placing the aqueous beta-glucan composition in the subterranean formation.

Aspect 50 provides the method of any one of Aspects 42-49, comprising diluting the aqueous beta-glucan composition to reduce the salinity thereof so that the aqueous beta-glucan composition has a Filterability Ratio of less than 2, or less than 1.2, prior to placing the aqueous beta-glucan composition in the subterranean formation.

Aspect 51 provides the method of any one of Aspects 42-50, comprising allowing the subterranean formation to heat the aqueous beta-glucan composition after injecting the aqueous beta-glucan composition in the subterranean formation so that the aqueous beta-glucan composition has a Filterability Ratio of less than 2, or less than 1.2.

Aspect 52 provides the method of any one of Aspects 42-51, comprising diluting the aqueous beta-glucan composition in the subterranean formation after injecting the aqueous beta-glucan composition in the subterranean formation so that the aqueous beta-glucan composition has a Filterability Ratio of less than 2, or less than 1.2.

Aspect 53 provides the method of any one of Aspects 42-52, comprising heating the subterranean formation using a heated injection fluid during or prior to placement of the aqueous beta-glucan composition in the subterranean formation.

Aspect 54 provides the method of any one of Aspects 42-53, comprising heating a tubular in the subterranean formation prior to or during injecting the aqueous beta-glucan composition through the tubular to place the aqueous beta-glucan composition in the subterranean formation.

Aspect 55 provides the method of Aspect 54, comprising reducing a flow rate of fluid in the tubular to increase a temperature of the tubular prior to or during injecting the aqueous beta-glucan composition through the tubular to place the aqueous beta-glucan composition in the subterranean formation.

Aspect 56 provides the method of any one of Aspects 42-55, comprising injecting fluid into the subterranean formation to lower salinity thereof prior to or during placing the aqueous beta-glucan composition in the subterranean formation.

Aspect 57 provides the method of any one of Aspects 42-56, wherein the subterranean formation has a pH of about 5 to about 10.

Aspect 58 provides the method of any one of Aspects 42-57, wherein the subterranean formation has a pH of about 6.5 to about 8.5.

Aspect 59 provides the method of any one of Aspects 42-58, wherein the subterranean formation has a temperature of about 0° C. to about 140° C.

Aspect 60 provides the method of any one of Aspects 42-59, wherein the subterranean formation has a temperature of about 60° C. to about 110° C.

Aspect 61 provides the method of any one of Aspects 42-60, comprising performing an enhanced oil recovery procedure in the subterranean formation using the aqueous beta-glucan composition.

Aspect 62 provides the method of Aspect 61, wherein the enhanced oil recovery procedure comprises polymer flooding.

Aspect 63 provides the method of any one of Aspects 61-62, wherein the aqueous beta-glucan composition in the subterranean formation sweeps petroleum in the subterranean formation toward a well.

Aspect 64 provides the method of Aspect 63, further comprising removing the petroleum from the well.

Aspect 65 provides a method of treating a subterranean formation, the method comprising:
placing the aqueous beta-glucan composition in a subterranean formation, such that the Filterability Ratio of the aqueous beta-glucan composition in the subterranean formation is less than 2.

Aspect 66 provides a method of treating a subterranean formation, the method comprising:

placing the aqueous beta-glucan composition in a subterranean formation; and

before the placing, during the placing, after the placing, or a combination thereof, heating the aqueous beta-glucan composition, diluting the aqueous beta-glucan composition to reduce the salinity thereof, or a combination thereof, such that the Filterability Ratio of the aqueous beta-glucan composition in the subterranean formation is less than 2.

Aspect 67 provides the refined beta-glucan, aqueous beta-glucan composition, or method of any one or any combination of Aspects 1-66 optionally configured such that all elements or options recited are available to use or select from.

1. A refined beta-glucan that forms an aqueous beta-glucan composition comprising 1 g/L of the refined beta-glucan, the aqueous beta-glucan composition having a salinity of 100,000 ppm TDS or less and having a Filterability Ratio of less than 2 at a temperature of at least 50° C.

2. The refined beta-glucan of claim 1, wherein the refined beta-glucan is in the form of a powder, a liquid concentrate, an aqueous beta-glucan composition having a concentration of the refined beta-glucan of other than 1 g/L, the beta-glucan composition comprising 1 g/L of the refined beta-glucan, or a combination thereof.

3. The refined beta-glucan of claim 1, wherein the refined beta-glucan is in the form of the aqueous beta-glucan composition comprising 1 g/L of the refined beta-glucan, having a salinity of 100,000 ppm TDS or less and having a Filterability Ratio of less than 2 at a temperature of at least 50° C.

4.-5. (canceled)

6. The refined beta-glucan of claim 1, wherein the aqueous beta-glucan composition having a salinity of 100,000 ppm TDS or less has a Filterability Ratio of less than 1.2 at a temperature of at least 50° C.

7. The refined beta-glucan of claim 1, wherein the refined beta-glucan forms an aqueous beta-glucan composition comprising 1 g/L of the refined beta-glucan, the aqueous beta-glucan composition having a salinity of 100,000 ppm TDS or less and having a Filterability Ratio of less than 2, or less than 1.2, at a temperature of at least 40° C.

8. The refined beta-glucan of claim 1, wherein the refined beta-glucan forms an aqueous beta-glucan composition comprising 1 g/L of the refined beta-glucan, the aqueous beta-glucan composition having a salinity of 180,000 ppm TDS or less and having a Filterability Ratio of less than 2, or less than 1.2, at a temperature of at least 60° C.

9. (canceled)

10. The refined beta-glucan of claim 1, wherein the refined beta-glucan forms an aqueous beta-glucan composition comprising 1 g/L of the refined beta-glucan, the aqueous beta-glucan composition having a salinity of 200,000 ppm TDS or less and having a Filterability Ratio of less than 2, or less than 1.2, at a temperature of at least 67° C.

11. The refined beta-glucan of claim 1, wherein the refined beta-glucan forms an aqueous beta-glucan composition comprising 1 g/L of the refined beta-glucan, the aqueous beta-glucan composition having a salinity of 200,000 ppm TDS or less and having a Filterability Ratio of less than 2, or less than 1.2, at a temperature of at least 55° C.

12.-13. (canceled)

14. The refined beta-glucan of claim 1, wherein the refined beta-glucan forms an aqueous beta-glucan composition comprising 1 g/L, of the refined beta-glucan, the aqueous beta-glucan composition having a salinity of 35,000 ppm TDS and having a Filterability Ratio of less than 2, or less than 1.2, at a temperature of at least 40° C.

15. The refined beta-glucan of claim 1, wherein the refined beta-glucan forms an aqueous beta-glucan composition comprising 1 g/L of the refined beta-glucan, the aqueous beta-glucan composition having a salinity of 35,000 ppm TDS and having a Filterability Ratio of less than 2, or less than 1.2, at a temperature of at least 22° C.

16.-28. (canceled)

29. A method of maintaining the Filterability Ratio of the aqueous beta-glucan composition of claim 1, the method comprising:
controlling temperature of the aqueous beta-glucan composition, salinity of the aqueous beta-glucan composition, or a combination thereof, such that the Filterability Ratio of the aqueous beta-glucan composition is less than 2.

30. A method of maintaining a Filterability Ratio of an aqueous beta-glucan composition, the method comprising:
controlling temperature of the aqueous beta-glucan composition, salinity of the aqueous beta-glucan composition, or a combination thereof, such that the Filterability Ratio of the aqueous beta-glucan composition is less than 2.

31. The method of claim 30 wherein the controlling of the temperature or salinity of the aqueous beta-glucan composition is performed above-surface, in a subterranean formation, or a combination thereof.

32. The method of claim 30, comprising controlling temperature of the aqueous beta-glucan composition, salinity of the aqueous beta-glucan composition, or a combination thereof, such that the Filterability Ratio of the aqueous beta-glucan composition is less than 2 and greater than or equal to 1.2.

33. The method of claim 30, comprising controlling temperature of the aqueous beta-glucan composition, salinity of the aqueous beta-glucan composition, or a combination thereof, such that the Filterability Ratio of the aqueous beta-glucan composition is less than 1.2.

34.-66. (canceled)
